(19) United States
(12) Patent Application Publication
(10) Pub. No.: US 2014/0143096 A1
(43) Pub. Date: May 22, 2014

(54) METHOD AND ARRANGEMENT FOR ENABLING EVALUATION OF PRODUCT ITEMS

(71) Applicant: Virtusize AB, Stockholm (SE)

(72) Inventors: Peder Stubert, Stockholm (SE); Christopher Wijkstrom, Stockholm (SE); Gustaf Tunhammar, Stockholm (SE); Erik Ekstrand, Stockholm (SE); Jevgenij Tsoi, Stockholm (SE)

(73) Assignee: Virtusize AB, Stockholm (SE)

(21) Appl. No.: 14/009,231

(22) PCT Filed: Apr. 4, 2012
(86) PCT No.: PCT/SE12/50372

§ 371 Date: Dec. 17, 2013

Related U.S. Application Data
(60) Provisional application No. 61/471,992, filed on Apr. 5, 2011.

(51) Int. Cl. G06Q 30/06

(52) U.S. Cl. CPC G06Q 30/0643; G06Q 30/0627
USPC 705/26.63

(57) ABSTRACT

Method, arrangement and system for enabling comparison of product items. The method comprises retrieving measurements of a first product item, selected by a user to be a reference product item; and further retrieving measurements of a second product item, which is to be evaluated. The measurements of the first product item are compared with the measurements of the second product item; and an indication of the correspondence of the measurements of the first product item and the measurements of the second product item is provided to a user of a terminal, thus enabling evaluation of the size of said second product item in relation to the size of the first product item.

### TECHNICAL FIELD

The invention relates generally to a method and arrangement for enabling evaluation of product items in a terminal connectable to a communication network

### BACKGROUND

Today, Internet offers a wide range of products. In the recent time, webstores, i.e. internet based stores, for sale of products has emerged. One example is stores selling clothes over Internet. However, the consumers may struggle with not being able to try the clothes which are being sold online. This may contribute to low conversion rates, i.e. a low ratio of purchasing visitors. Moreover, the rate of returns of purchased goods may become high. A high return rate may be expensive and also possibly contribute with a negative environmental impact.

The most important reason for consumers to hesitate to purchase over the internet is that consumers cannot try the purchase candidate on. Thus, the consumer may not know if the size of the purchase candidate will fit them. Many garments indicate their size through labels such as Small, Medium and Large. The problem with such labeling, as well as other systems comprising size indicators is that they differ greatly between different brands and sometimes also for different garments of the same brand. This may induce consumer insecurity over choosing the right size. This insecurity may hamper the consumers from making the purchase decision.

For the consumers that actually do purchase clothes, or other products, online, not being able to try clothes on before purchasing may lead to an unnecessary large number of customers ordering clothes in the wrong size and/or fit. Those clothes are often returned by the consumer, which may lead to high return rates. Returning purchased items is troublesome for consumers. Further, return of items is very costly for webstores, not just due to shipping and handling costs, but also inventory and the fact that returned items may be out of season or fashion when they are returned and may have to be sold at a discount which contributes to a negative impact on the overall profitability.

Today, webstores have mainly two different systems of indicating size and fit to the consumer in order to facilitate a correct choice of size and fit. These methods are body measurements and product item measurements, of which body measurements dominate. With reference to FIG. 1, a table of body measurements is disclosed. The Body Measurements method is cumbersome for the consumer as it is not without difficulty to interpret the body measurements tables or to measure one's own body. The accuracy of the body measurements method may not be accurate enough since it is probable that the consumer will not have the same preferences for fit as the webstore or the brand owner.

When using product item measurements, the webstore displays a list of some measurements of the item which is a purchase candidate such that the customer can compare it to the measurements of the own body or another comparable item. However, this is cumbersome for a customer. Further, only product item measurement values may not provide the customer with sufficient information to reassure that the item is adequate

There are a lot of insecurities when it comes to sizes of product items, especially garments, and whether the product item will fit or not. Thus, a better system for evaluating size and fit of product items, such as garments, is needed.

### SUMMARY

The invention generally relates to evaluation of the size of product items. More specifically, the invention relates to comparing the size and/or fit of a first product item to the size and/or fit of a second product item (or a whole group of product items), using a terminal which is connectable to a communication network. The second product item is offered to the user via a store, such as an online webstore. The store may use e.g. a product item database in order to provide the product item measurements to the terminal. Then, an indication of a comparison between the product items may be provided to the user. For example, the user may be enabled to visually compare the first product item and the second product item. Thereby, the user may relate the size and/or fit of the second product item to the first product item with a known size and/or fit, and thus evaluate the second product item. This method, arrangement and system may help users to identify adequate product items, e.g. garments fitting the own body in a satisfying way. Thus, the number of purchased product items that need to be returned, e.g. due to wrong size, may be lowered, which is not only a relief for the customer, but also beneficial to the provider of the product item and reduces transports, which is beneficial for the environment. Further, items of a size and/or fit corresponding to that of the first product item could be recommended to the user, which thereby easily can find and evaluate suitable purchase candidates. Alternatively or in addition, the user could search for or filter out items having measurements corresponding to one or more items, of which the measurements are stored in a database accessible by the user. Such a search may also take other parameters than measurements into account, e.g. regarding color or materials.

Further possible features and benefits of this solution will become apparent from the detailed description below.

### BRIEF DESCRIPTION OF DRAWINGS

The invention will now be described in more detail by means of exemplifying embodiments and with reference to the accompanying drawings, in which:

FIG. 1a-d illustrate typical size and measurement charts from the prior art.

FIG. 2a illustrates a product item measurement, according to one possible embodiment.

FIG. 2b illustrates another set of measurements applicable for visualization, according to one possible embodiment.

FIG. 3a illustrates a block chart of a terminal, a webstore and a product item measurements database, according to one possible embodiment. Interaction between the different entities is also illustrated in the figure.

FIG. 3b illustrates a terminal using a semantic search engine to gather offers from webstores.

FIG. 4 illustrates a flow chart, describing the procedure of visually comparing two product items, according to one possible embodiment.

FIG. 5 illustrates a terminal visualization, according to one possible embodiment.

FIG. 6 illustrates a terminal used for scanning codes in a physical store, according to an exemplifying embodiment.

FIG. 7a-b illustrate different components in an exemplifying implementation and associated hardware.

FIG. 8 illustrates a block chart of a terminal, a provider, such as a store, and a reference database, according to one possible embodiment.

FIG. 9-11 are flow charts illustrating exemplifying procedures for enabling evaluation of product items in a terminal, according to the suggested technology.

FIG. 12-13 are block charts illustrating exemplifying arrangements for enabling evaluation of product items in a terminal, according to the suggested technology.

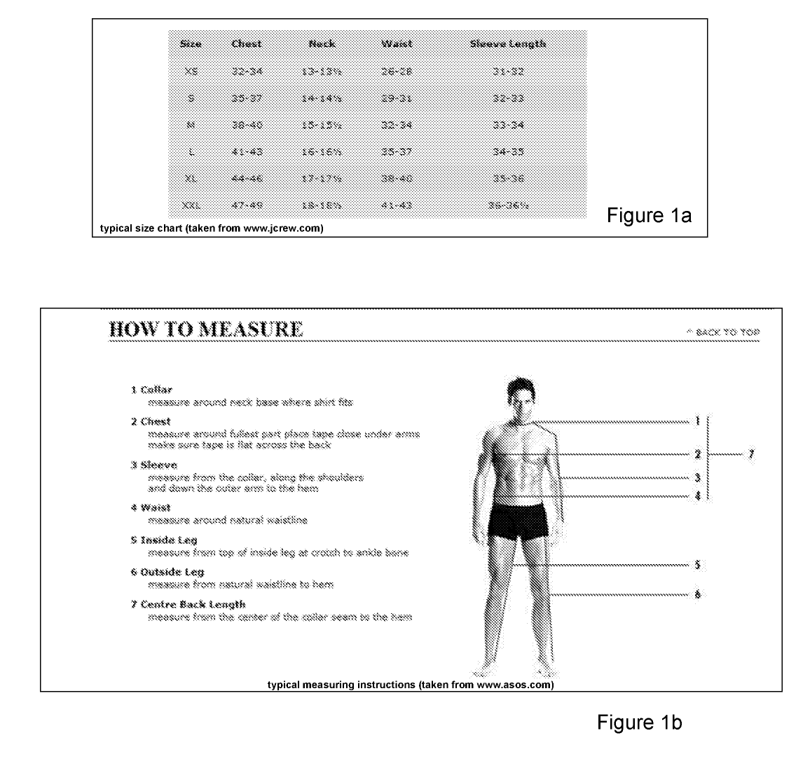

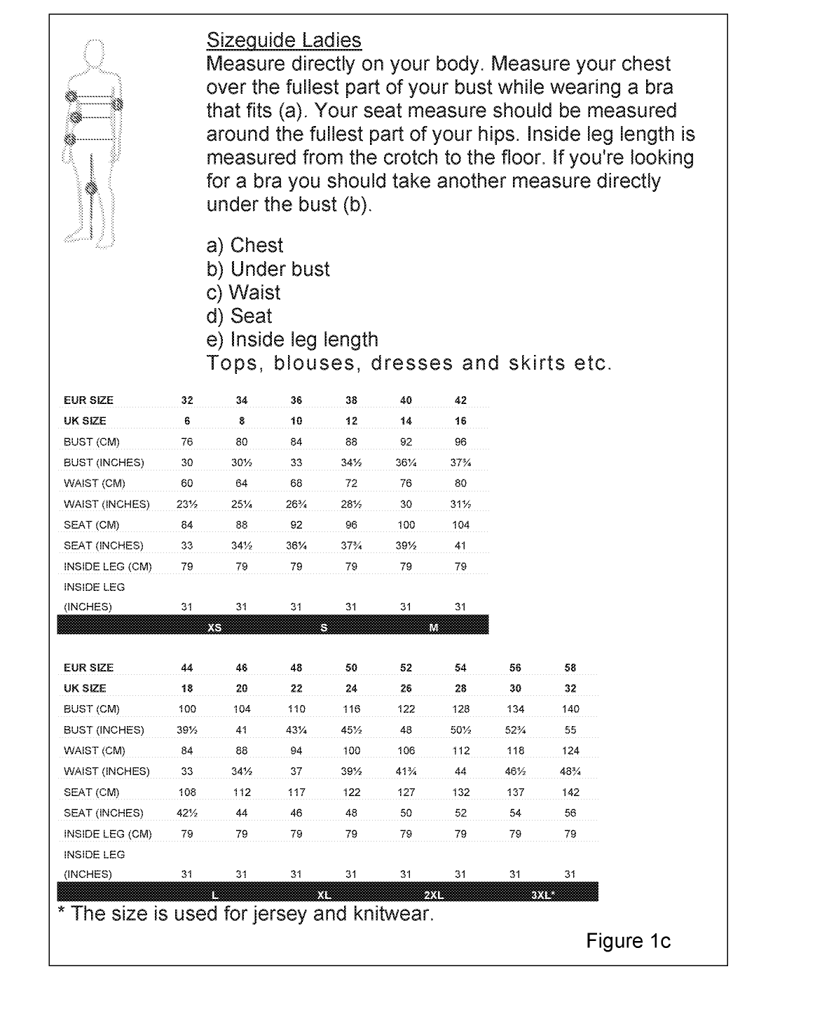

### DETAILED DESCRIPTION

Briefly described, a solution is provided for enabling evaluation of items in a terminal connected to a communication network. Measurements associated with two different items, one known to fit, and one other are retrieved. The measurements of the two items are compared, and the items are visualized to a user, based on the measurements and comparison, such that a user easily can determine whether the item of unknown size and fit is of the right size and or fit (or not).

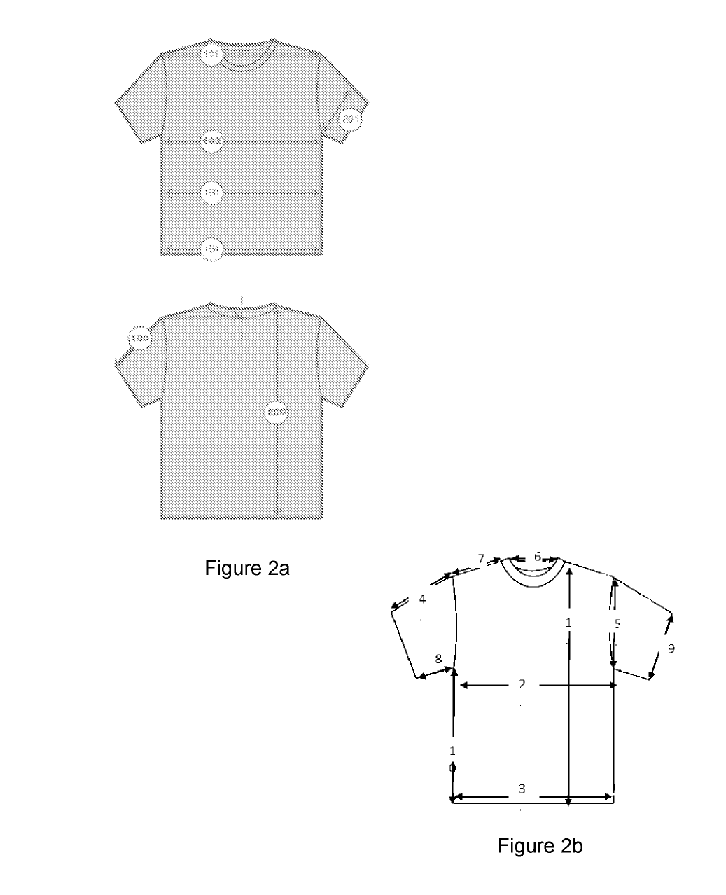

With reference to FIG. 2, one way to gather product item measurements will now be described. Each item may need to be measured according to a standardized way in order to enable the consumer to compare product items from different manufacturers and also by comparing different models of the same type of product items. One non-limiting example is to measure trousers, which are known to be measured in various different ways by different manufactures. In fact, the same trouser manufacturer may even measure differently between different trouser models.

By using the herein suggested solution at least four effects may be achieved. The insecurity due to the difficulty of getting an idea of size and fit only by comparing charts and numbers may be decreased. The difficulty of comparing different sizes and fit of different sizes of the same product item type may be eliminated. The need for a consumer to measure a well fitting product item multiple times may be eliminated. Instead a database comprising the measurements of product items known to fit may be used. Further, the consumer may search for product items based on preferred size or fit and will have the possibility to filter out product items which do not conform to defined preferences/rules for size and fit.

With reference to 3a, a block chart illustrating a flow for a procedure of visually comparing two product items in a terminal. The terminal comprises general interface for interacting with the user, e.g. a screen and a keyboard, a touch screen or similar. The terminal is in connection to a communication network, such as Internet. The user of the terminal requests to compare a first product item with a second product item. Then, according to action 3:1, the terminal issues a request for comparison to a server which is hosting the webstore. Thus, the server receives the request, which is indicated in action 3:2, from the terminal via the communication network.

The webstore determines, in action 3:3, based on the request in action 3:2, the measurements of the second product item, which is stored at the webstore. The measurements could alternatively be determined and/or stored at some other location, such as at a central measurement provider or at another webstore, being a “primary” webstore administrating, hosting or owning the measurements. The webstore issues a request, in action 3:4, to a product item measurements database via the communication network. The product item measurements database comprises measurements of product items which are associated with users. Thus, based on a user identity, a set of product measurements corresponding to a predefined set of product items may be provided. The database receives the request in action 3:5, which comprises the user identity. The user database looks up and provides at least one measurement associated with the first product item, in actions 3:6 and 3:7. The measurements associated with the first (reference) product item may be provided by different possible methods. According to one example, the measurements are manually provided to the database. Further, the measurements could be provided by “tagging” a known (e.g. previously purchased) item e.g. at a webstore site. According to another example, the user of the terminal may manipulate another known product item, such as a “tagged” item or a stored reference item, by adjusting one or more product item measurement. According to yet another example, the product item measurements associated with the product item may be provided to the database by using image analysis or bar codes such as Quick Response (QR) codes. According to yet another example, the product item measurements associated with the product item may be provided to the database by image analysis of the product item, i.e. measurements are derived from a photo representation of the product item. According to yet another example, the product item measurements associated with the product item may be provided to the database by “Blueprints” used in production of product items.

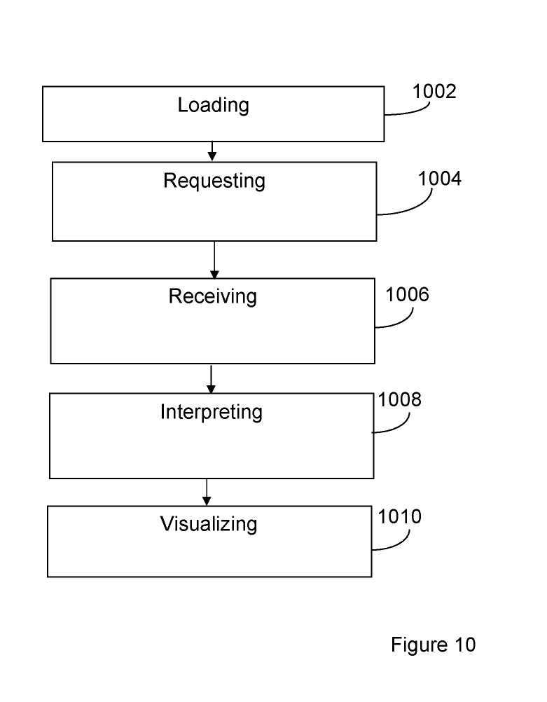

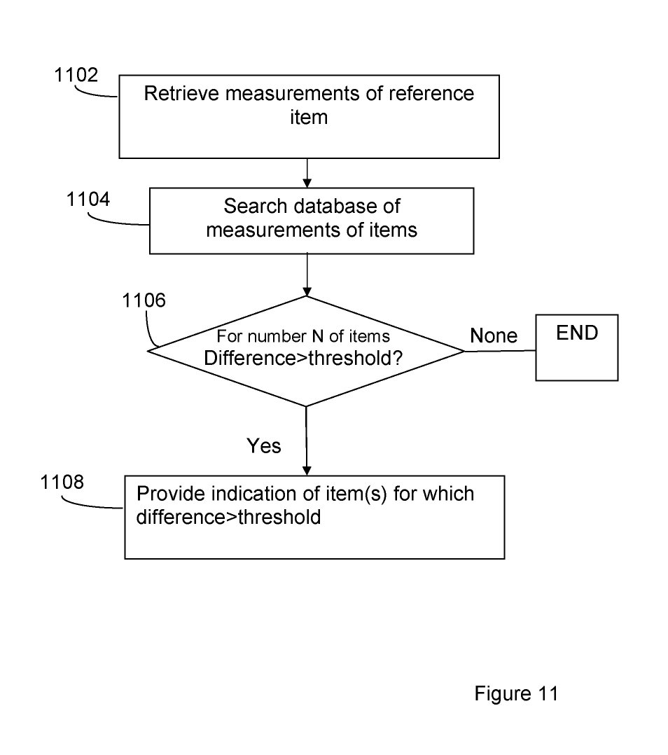

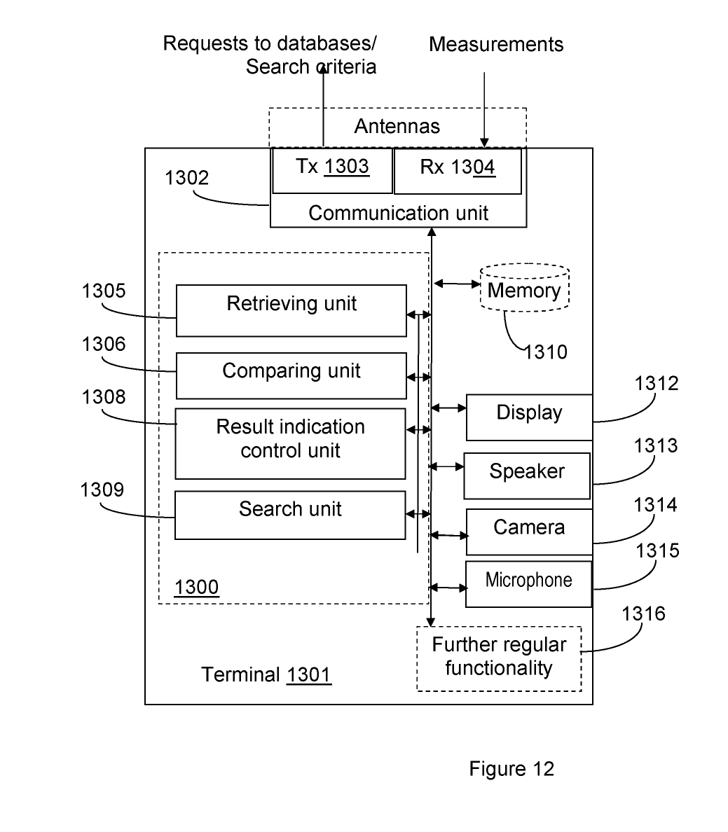

The webstore receives the measurements from the database in action 3:8. Then, the terminal may compile the measurements of the first and the second product item in action 3:9. However, it is also possible that the measurements of the first and the second product items are compiled in the webstore. The webstore provides instructions to the terminal, in action 3:10 to visually compare the first and the second product item, based on the individually associated product item measurements. When the terminal receives the instructions, in action 3:11, the terminal interprets and renders the visual comparison which is provided to a monitor to be displayed to the user in action 3:12. The actions described above are also illustrated in FIG. 10.

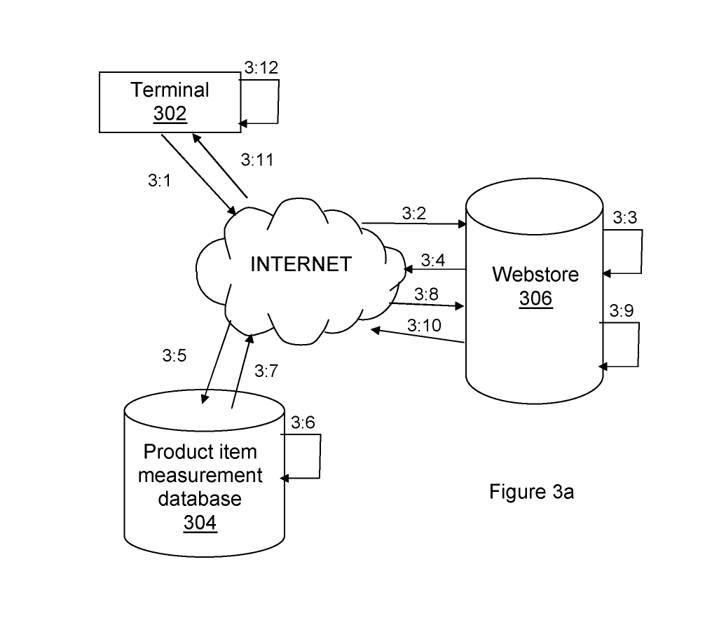

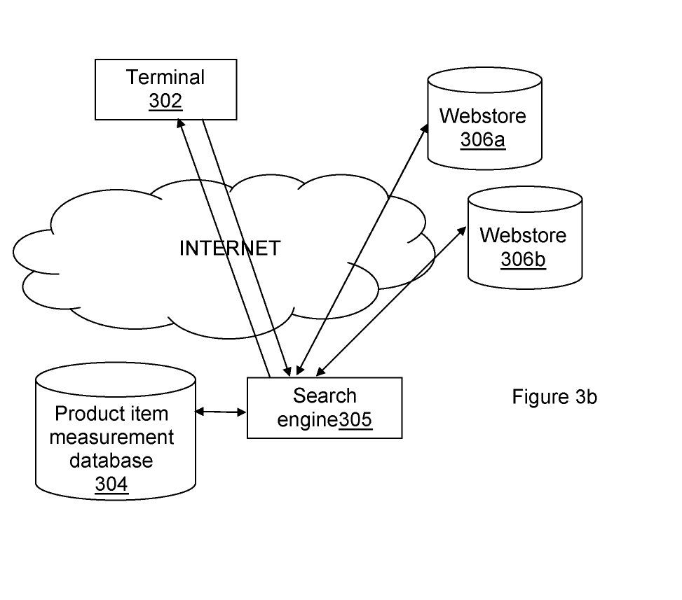

Hence, by using the arrangement which is described above with reference to FIG. 3b, the user may compare items from several webstores to reference product items stored in the product item measurements database. In other words, the user is enabled to compare second product items from various different stores to a set of known first product items which are stored in the product item measurements database.

According to one optional and possible embodiment, the webstore in FIG. 3a, may suggest product items to the user of the terminal, based on at least one first product item which is associated with the user.

With reference to FIG. 3b, a procedure in a terminal will now be described. The terminal loads the visual provided from the webstore in order to display the product items which are being sold. Then, the user requests a product item comparison. Hence, a request is sent to the server hosting the webstore. The terminal interprets instructions together with measurements associated with a first and a second product item. Then, the terminal interprets the instruction and compares the measurement of the first product item to the measurements of the second product item. In a final step, the terminal visualizes the first and second product item by superimposing rendered graphical representations, i.e. a graphical representation of the first product item is superimposed over the graphical representation of the second product item. The two items are visualized using a set of measurements rules which are provided either by the webserver, or which is inherent to the terminal.

Hence, by using the procedure illustrated in FIG. 10, and/or by using the arrangement as described in FIG. 3a or 3b, the user may apply product item filters which are adapted to filter based on parameters such as fit and size in addition to other attributes, such as color and type.

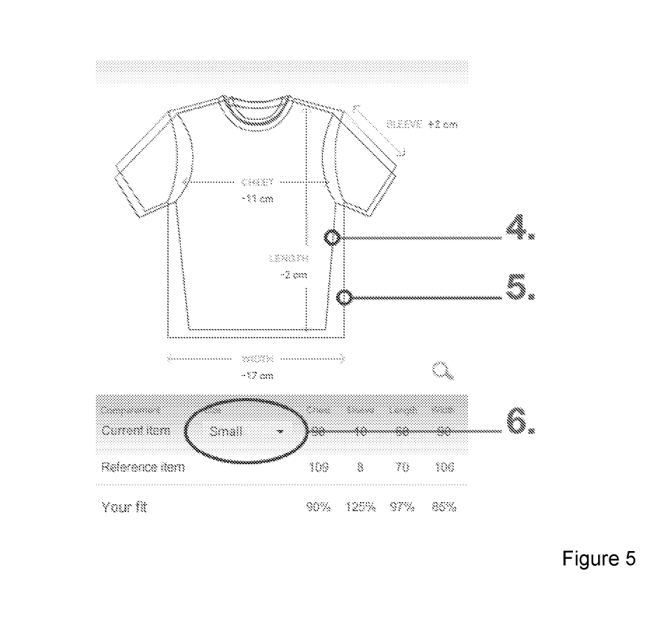

With reference to FIG. 5, the result from the visualizing action in FIG. 10 will now be described. It should be noted, that the representation in FIG. 5 is merely an example of how a first and a second product item may be visually compared. Although the product items in FIG. 5 happen to be two garments, other types of product items are naturally also possible. For instance, entertainment electronics, paintings, mirrors, shoes, hats and so on.

The visualization in FIG. 5 combines a visual representation by superimposing a graphical representation of the first product item (1), and a graphical representation of the second product item (2), as well as providing the user with a relative difference in product item measurement. This interface may also provide additional information and also enable the user to easily switch the first and/or second product item. According to one example, the graphical representation may be an outline of the product item. For example, if the first and second product items are t-shirts, the graphical representation which is superimposed is two outlines, or silhouettes, of the two t-shirts.

The visualization may be performed based on a set of visualization rules. If one or more of the necessary measurements for visualization is missing, then the rules determine an interim measurement. One such example rule may be that the width for the neck-opening is 30% of the total shoulder width. Similarly, determining rules may be applied for other measurements as well for other types of product items.

Users, i.e. consumers, will be able to avoid having to measure their garments altogether. Instead, they will be able to choose measurements from either an item that they have previously bought at a webshop or an item that they own. If a user knows that a pair of Levis' jeans, model 501, size 31/32 are a good fit for the consumer, the consumer would be able to pick up these product item measurements from the database.

According to another alternative to actually measuring the known first product item by hand could be to use image analysis, which exists in profusion. For example by using a cellular phone hosted application whereby measurements of an item can be retrieved simply by photographing it. According to another example, QR codes may be used in order to represent the product item measurements in a database. Thus, if the user takes a photo, using for example a mobile phone, of the QR code of a first product item, the measurements may be preloaded in the database by the manufacturer of the first product item. Naturally, QR code may be used in a reversed order. I.e. by comparing a physically sold product item by capturing the QR code and compare it to the prestored first product item.

For example, a user may enter a physical store vending e.g. garments. Instead of trying on a garment of interest in a fitting room, which many find troublesome, the garment of interest could easily be compared with a reference garment, known by the user to be of the right size and fit, by use of the herein suggested solution. Thereby, the size and/or fit of the garment of interest could be evaluated without having to go through the procedure of trying it on. The comparison may be performed using any terminal which has the required means for interacting with a user, e.g. a display, has access to the required measurements (e.g. is connectable to a network via which the measurements can be downloaded), and which is enabled to perform an embodiment of the solution described herein (and for which the technology described herein is implemented, e.g. in case of so-called apps.

Such a terminal could be e.g. the smartphone or tablet of the user or a smartphone, tablet, portable computer or dedicated device supplied by the store. The terminal could be adapted to the solution described herein e.g. by the downloading of an application e.g. from an app-store, or the solution described herein may be performed e.g. in a webbrowser run on the terminal. The application could comprise computer code, which when executed in the mobile terminal and/or elsewhere results in a comparison and superposition of graphical representations on a display of two garments, one known to fit, and one of unknown fit. The measurements of the garment of interest could be derived from a database by use of the capturing or scanning of a code associated with the garment, where the code represents the garment or the measurements of the garment.

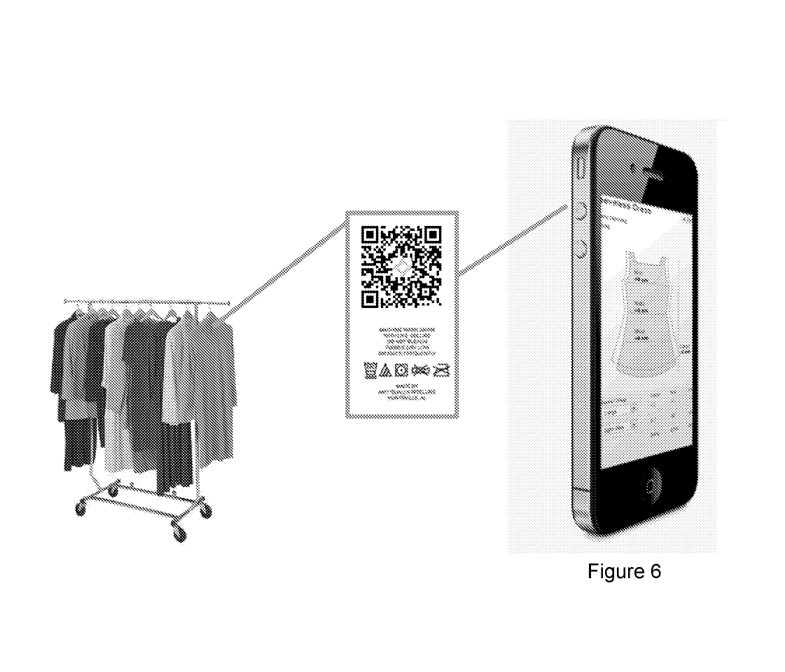

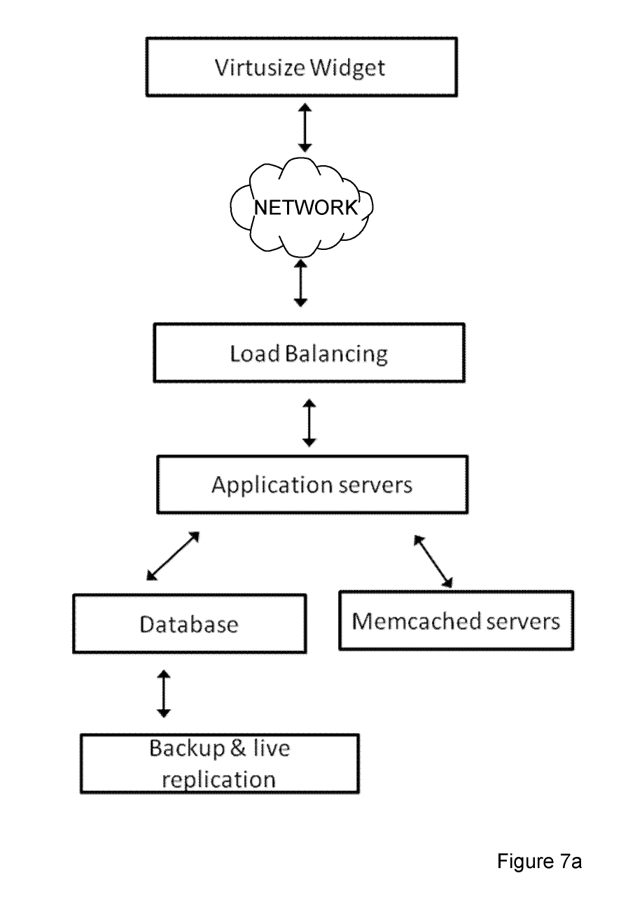

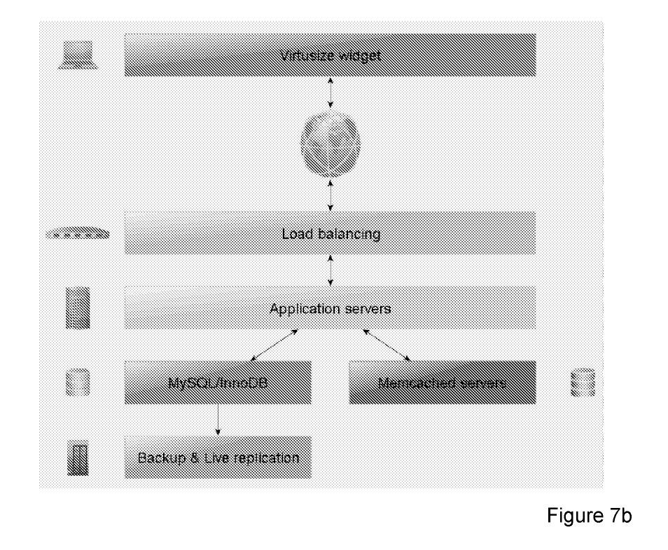

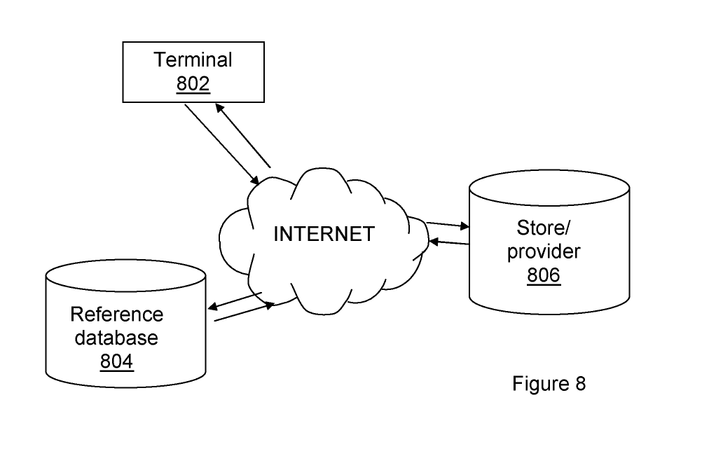

According to another alternative solution, the user may be able to use the measurements of a known first product item to search multiple webstores in parallel, which is illustrated briefly in FIG. 6. Thereby, a search for products using product item measurements as search semantic may be applied. The measurements associated with the first product item will still be comprised in a reference database. In order to perform the search, a product item search engine will be added to the arrangement of FIG. 3. The product item search engine will interact with two or more webstores based on the request from the user using the terminal. Thus, the user may search, in one particular webstore or in a set of webstores, for product items having a substantial similar fit and size as a known first product item.

Further, a solution may be provided for finding one or more product items in a physical store, which items have measurements corresponding to a reference product item. This may require that the measurements of the product items for sale in the physical store are organized in a database, e.g. in association with their physical location in the store. The physical location in the store may then be displayed to the user together with the information associated with the size and/or fit of the product item.

According to one embodiment of the invention, a method is provided in a terminal for visually comparing at least one first and at least one second product item. The method comprising: requesting, from a webstore, product items measurements individually associated with at least one first product item and at least one second product item, wherein the measurements of said first at least one product item is stored in a database connected to said webstore; The method further comprises receiving the requested product item measurements and—visualizing, to a user using a screen, a comparison of said at least one first product item and said at least one second product item by superimposing a graphical representation of said first product item and said second product item.

According to another embodiment of the method, the visualizing action may further comprise to provide a numerical relative comparison between at least one first product item and at least one second product item.

A system is provided for providing visual comparison to a user. The system comprises a terminal, connected to a communication network and capable of interacting with a user by at least using a monitor. The system further comprises a database, which is adapted to be in connectivity to a webserver, comprising product item measurements associated with at least one first product item, wherein said at least one first product item is associated with said user of said terminal; The system further comprises a webserver, adapted to host a webstore, comprising at least one set of measurements associated with a second product item, said webserver is further in connection to said terminal; wherein said terminal is adapted to issue a request of product item comparison to said webserver, said request comprising indictors of at least one of said at least one first product item and said at least one second product item, wherein said webserver is further adapted request the measurements of said at least one first product item from said database. The webserver is adapted to, in response to receiving the requested product item measurements, provide visualization instructions to said terminal, wherein said terminal is adapted to interpret the instructions and visually display a superimposed graphical representation of said at least one first product item and said at least one second product item using the display to the user.

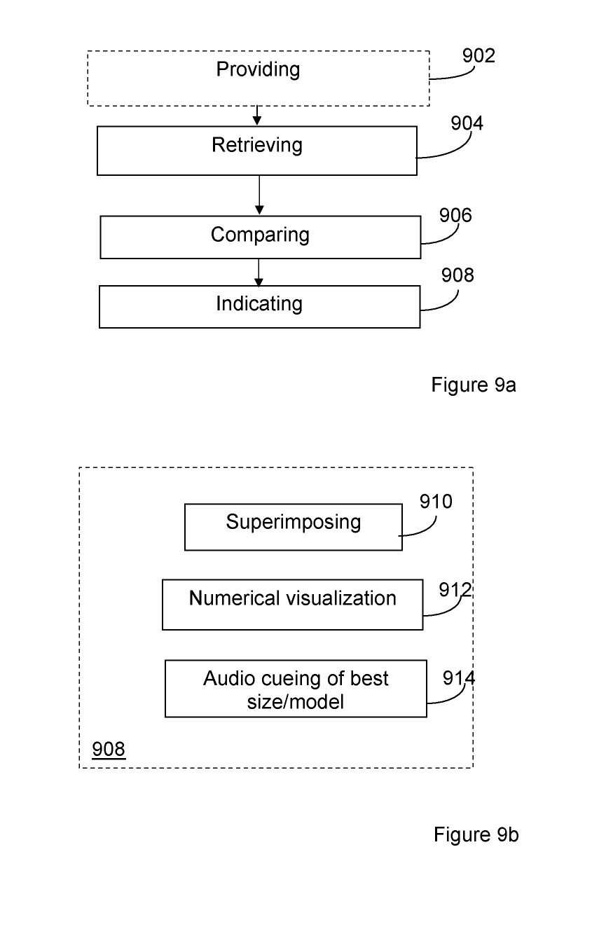

Exemplifying Procedure, FIG. 9a-b

An exemplifying procedure in a mobile terminal according to the technology suggested herein will be described below with reference to FIGS. 9a and 9b.

Measurements of a first product item are retrieved in an action 904. The first product item is selected by a user to be a reference product item, and is retrieved from a reference database. A reference database is built up or created by a user, and comprises measurements of reference product items provided to the database by the user. The providing of reference product items is illustrated by action 902 in FIG. 9a. The providing may involve e.g. manual input of measurements via a graphical user interface on a terminal; scanning of a code representing the measurements; retrieval of the measurements from a provider of the product item and/or image analysis of a photo representation of the product item. The measurements could also be derived e.g. from spec-sheets, production blueprints or other drawings (to scale) of the product item, e.g. used during production of the product item.

Further, measurements of a second product item, which is to be evaluated, are retrieved from a database (also illustrated by action 904). The retrieving of the measurements of the second product item may involve indication (by the user) of the second product item in a graphical user interface, and/or scanning of a code representing the second product item and/or the measurements thereof. The code may be e.g. a linear or matrix bar code.

The measurements of the first product item are compared with the measurements of the second product item in an action 906. Further, an indication of the correspondence of the measurements of the first product item and the measurements of the second product item is provided to a user of the terminal. The use of the above described procedure enables the user to evaluate the size of said second product item in relation to the size of the first product item.

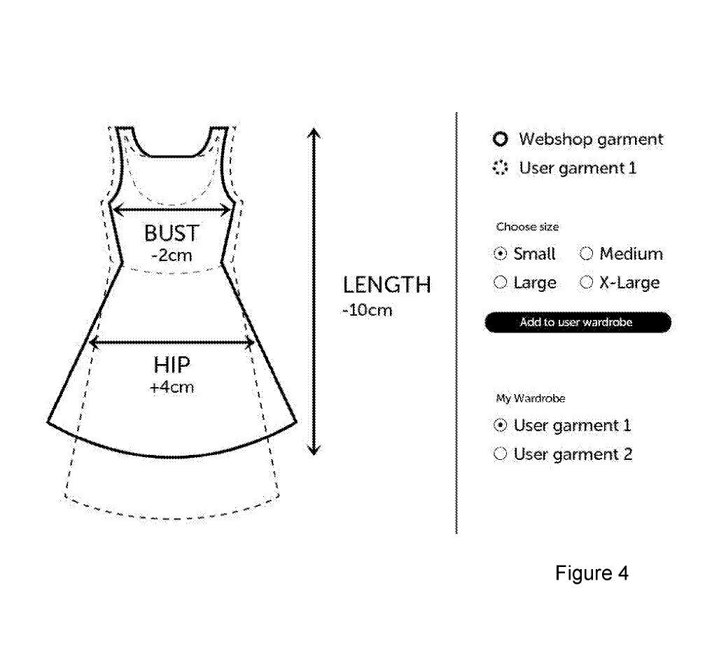

The action 908 of providing of an indication of the correspondence of the measurements of the two product items is further illustrated in FIG. 9b. The action 908 may involve superimposing 910 a graphical representation of the first product item and a graphical representation of the second product item on a display. The graphical representations should have a common scale and be based on the measurements of the first and second product item. The graphical representations should be separable from each other, e.g. as illustrated in FIG. 4, where a broken line is used for one of the items and a solid line for the other item.

Further, numerical indications of the differences between the measurements of the first product item and the second product item may be visualized in association with the superimposed graphical representations. For example, a numerical value in centimeters, inches or percent could be associated with e.g. with a certain measurement (cf. numerical values in cm in FIG. 4).

Alternatively or in addition, the providing of an indication may involve giving a cue, such as an audio cue, or an alphabetical or numerical cue, to the user, which indicates e.g. the size or category of a certain model of product item which would fit the user. For example, if a certain model is identified by the user and compared to a reference product item, and the size or category “medium” (of the categorys “small”, “medium”, “large”, “X-large”) has the smallest difference in measurements in relation to the reference product item, the audio cue “Medium” may be presented to the user. Alternatively, the cue “medium” may be given alphabetically on a display, e.g. in association with a graphical representation of a product item (of the model in question) of size medium being superimposed on a graphical representation of the reference product item.

The procedure illustrated in FIG. 9a may further comprise deriving a whole set of measurements of product items (not explicitly illustrated in FIG. 9a). For example, the set may be derived by a search request sent to a search engine which searches one or more databases. The search request may comprise search criteria defining the search. For example, the search criteria may be related to a certain allowed deviation from the measurements of a reference product item. Thus, the derived set may comprise measurements of product items for which a difference in measurements as compared to the reference product item fulfills the search criterion (predefined criterion).

Further, the second product item discussed above may be a/the product item out of the set, which is associated with the smallest deviation from the measurements of the first product item, i.e. the reference product item. The “smallest deviation” may be defined in different ways. The difference between certain measurements may be considered, e.g. by the user, more important than others, and therefore be weighted higher than others. For example, if one product item, A, in the set deviates 4 cm in the hip-measure and another product item, B, in the set deviates 4 cm in the length-measure, and the hip-measure has been defined as more important than the length-measure, the product item B will be the one (out of A and B) having the smallest deviation from the reference product item. Alternatively or in addition, the smallest deviation may be calculated using e.g. methods like MSE (Mean Square Error) or similar.

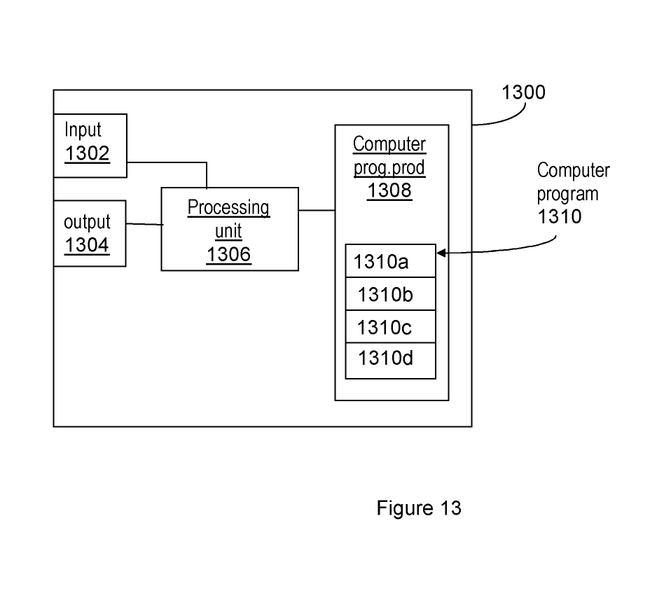

### Exemplifying Arrangement, FIG. 13

Below, an exemplifying arrangement 1300, adapted to enable the performance of the above described procedure will be described with reference to FIG. 13. The arrangement is assumed to be located in a terminal 1301, which could be e.g. a mobile phone, such as a smartphone; a tablet or a computer (preferably easily portable, but semi-stationary also possible).

The arrangement 1300 and/or terminal 1301 is illustrated as to communicate with other entities via a communication unit 1302, which may be considered to comprise means for wireless and/or wired uplink and downlink communication. The terminal is assumed to comprise means for user interaction, such as e.g. display 1312, speaker 1313, camera 1314 and/or microphone 1315. The arrangement and/or terminal may further comprise other functional units 1314, for providing e.g. regular terminal functions. The arrangement and/or network node may further comprise one or more storage units 1310.

The arrangement 1300 could be implemented by processing circuitry, e.g. by one or more of: a processor or a micro processor and adequate software (and storage therefore), a Programmable Logic Device (PLD) or other electronic component(s)/processing circuit(s) configured to perform the actions described above in conjunction with FIG. 9a-b.

The arrangement 1300 may be implemented and/or described as follows: The arrangement 1300 comprises a retrieving unit 1305, adapted to retrieve, from a reference database, measurements of a first (reference) product item, and further to retrieve measurements of a second product item, which is to be evaluated. The arrangement further comprises a comparing unit 1306, adapted to compare the measurements of the first product item with the measurements of the second product item. The arrangement further comprises a result indication control unit 1308, adapted to provide an indication of the correspondence of the measurements of the first product item and the measurements of the second product item to a user of the terminal, thus enabling evaluation of the size of said second product item in relation to the size of the first product item.

The arrangement may further comprise a search unit 1309, adapted to provide search criteria to a search engine, where the search criteria relates at least to a maximum deviation from the measurements of a reference product item, thus enabling the search engine to search for product items in one or more databases, and to provide a set of measurements of product items, which fulfill the search criteria. The arrangement may further be adapted to support providing of measurements of a reference product item to the reference database.

It is to be understood that the choice of interacting units, as well as the naming of the units are only for exemplifying purpose, and terminals suitable to execute any of the methods described above may be configured in a plurality of alternative ways in order to be able to execute the suggested process actions. Even though the technology suggested herein is mostly described in the context of clothes and garments (for which it is very advantageous), other applications are also possible, such as e.g. furniture, entertainment electronics, paintings, mirrors, shoes, hats and similar.

While the suggested technology has been described with reference to specific exemplary embodiments, the description is generally only intended to illustrate the concept and should not be taken as limiting the scope of the invention. For example, the terms “webserver”, “product items”, “database” and “terminal”, have been used throughout this description, although any other corresponding functions, parameters, nodes and/or units having the functionalities and characteristics described herein could be used.

1. Method in a terminal in a communication system, for enabling evaluation of product items, the method comprising:
retrieving from a reference database, measurements of a first product item, selected by a user to be a reference product item;
retrieving from a database, measurements of a second product item, which is to be evaluated;
comparing the measurements of the first product item with the measurements of the second product item; and
providing an indication of the correspondence of the measurements of the first product item and the measurements of the second product item to a user of the terminal, thus enabling evaluation of the size of said second product item in relation to the size of the first product item.

2. Method according to claim 1, wherein the providing of an indication involves:
superimposing a graphical representation of said first product item and a graphical representation of said second product item on a display, where the graphical representations have a common scale and are based on the measurements of said first and second product item.

3. Method according to claim 2, further comprising:
visualizing, in association with the superimposed graphical representations, numerical indications of the differences between the measurements of the first product item and the second product item.

4. Method according to claim 1, further comprising:
deriving a set of measurements of product items, for which product items a difference in measurements as compared to the first product item fulfills a predefined criterion.

5. Method according to claim 4, wherein the second product item is a product item out of the set, having the smallest deviation from the measurements of the first product item.

6. Method according to claim 5, wherein the indication involves identifying, to the user, a category of the second product item.

7. Method according to claim 1, further comprising:
providing the measurements of a reference product item to the reference database by use of at least one of:
manual input of measurements via a graphical user interface on a terminal;
scanning of a code representing the measurements;
retrieval of the measurements from a provider of the product item;
retrieval of the measurements from production blueprints of the product item;
image analysis of a photo representation of the product item.

8. Method according to claim 1, wherein the measurements of the second product item is retrieved based on at least one of:
an indication of the second product item in a graphical user interface;
scanning of a code representing the second product item and/or the measurements thereof;
wherein one product item in the set is the second product item.

9. Arrangement in a terminal operable in a communication system, for enabling evaluation of product items, the arrangement comprising:
a retrieving unit adapted to retrieve, from a reference database, measurements of a first product item, selected by a user to be a reference product item, and further to retrieve measurements of a second product item, which is to be evaluated;
a comparing unit adapted to compare the measurements of the first product item with the measurements of the second product item; and
a result indication control unit adapted to provide an indication of the correspondence of the measurements of the first product item and the measurements of the second product item to a user of the terminal, thus enabling evaluation of the size of said second product item in relation to the size of the first product item.

10. Arrangement according to claim 9, wherein the providing of an indication involves superimposing a graphical representation of said first product item and a graphical representation of said second product item on a display where the graphical representations have a common scale and are based on the measurements of said first and second product item, thus enabling evaluation the size of the second product item in relation to the size of the first product item.

11. Arrangement according to claim 10, being further adapted to visualize, in association with the superimposed graphical representations, numerical indications of the differences between the measurements of the first product item and the second product item.

12. Arrangement according to claim 9, wherein the terminal further comprises means for providing measurements of a reference product item to the reference database by at least one of:
manual input of measurements via a graphical user interface;
scanning of a code representing the measurements;
retrieval of the measurements from a provider of the first product item;
image analysis of a photo representation of the product item.

13. Arrangement according to claim 9, wherein the retrieving of the measurements of the second product item is based on at least one of:
an indication of the second product item in a graphical user interface;
scanning of a code representing the second product item and/or the measurements thereof.

14. Arrangement according to claim 9, further comprising:
a search unit adapted to provide search criteria to a search engine, where the search criteria relates at least to a maximum deviation from the measurements of a reference product item, thus enabling the search engine to search for product items in one or more databases, and to provide a set of measurements of product items, which fulfill the search criteria.

15. Computer program comprising computer readable code means, which when run in an arrangement causes the arrangement to perform the method according to claim 1.

16. Computer program product, comprising the computer program according to claim 15.

17. System for enabling evaluation of product items, the system comprising:
a terminal comprising an arrangement according to claim 9, and further comprising means for interacting with a user;
a reference database comprising measurements of reference product items associated with a user;
at least one second database comprising measurements of product items associated with a provider of product items.

18. System according to claim 17, further comprising a search engine for searching at least the second database, based on search criteria received from the terminal and delivering search results to the terminal in form of a set of measurements associated with product items.

19. Terminal comprising an arrangement according to claim 9.
